(19) United States
(12) Patent Application Publication
(10) Pub. No.: US 2008/0079363 A1
(43) Pub. Date: Apr. 3, 2008

(54) Plasma display panel and method of manufacturing the same

(75) Inventors: Takashi Yoshinaga, Higashimorokata (JP); Tatsuhiko Kawasaki, Miyazaki (JP)

Correspondence Address: MCDERMOTT WILL & EMERY LLP, 600 13TH STREET, N.W., WASHINGTON, DC, 20005-3096, US

(73) Assignee: FUJITSU HITACHI PLASMA DISPLAY LIMITED

(21) Appl. No.: 11/790,126

(22) Filed: Apr. 24, 2007

(30) Foreign Application Priority Data
Sep. 29, 2006 (JP) 2006-268877

(51) Int. Cl. H01J 11/02

(52) U.S. Cl. 313/581; 445/22

(57) ABSTRACT

In a plasma display panel having a discharge gas sealed in a gap between a front side substrate and a rear side substrate opposed to each other and having ribs partitioning a gas-sealed space into a discharge cell array arranged above an inner surface of one of the substrates, the rib includes an upper-layer rib and a lower-layer rib, and the upper-layer rib and the lower-layer rib are made of rib materials different from each other in resistance to etching, thereby allowing for formation of high ribs to enlarge the discharge space without affecting the upper-layer ribs when forming the lower-layer ribs.

### CROSS-REFERENCE TO RELATED APPLICATIONS

This application is based upon and claims the benefit of priority from the prior Japanese Patent Application No. 2006-268877, filed on Sep. 29, 2006, the entire contents of which are incorporated herein by reference.

### BACKGROUND OF THE INVENTION

1. Field of the Invention

The present invention relates to a plasma display panel and a method of manufacturing the same.

2. Description of the Related Art

As a flat-type display device, a plasma display device with a plasma display panel (PDP) is put into practical use in which pixels on the screen are caused to emit light according to display data. In a plasma display panel of a surface discharge type, a plurality of surface discharge electrodes are formed on the inner surface of the front glass substrate, and the surface discharge electrodes are covered by a dielectric layer and a protective layer. On the inner surface of the rear glass substrate, ribs are formed, and phosphor layers are formed which are made by applying phosphors of red (R), green (G), and blue (B) being three primary colors between the ribs. The plasma display panel of the surface discharge type has a structure in which the front glass substrate and rear glass substrate are sealed together and a rare gas is sealed in between. In the plasma display panel of the surface discharge type, when a predetermined voltage is applied between the surface discharge electrodes, discharge occurs in the discharge space formed by the ribs, and the ultraviolet rays produced by the discharge excite the phosphors to emit light, thereby performing color image display.

Methods of improving the light emission efficiency in the plasma display panel include a method of enlarging the discharge space. It is necessary to increase the height of the rib in order to enlarge the discharge space while maintaining the image quality such as resolution and the like, but simple increasing the height of the rib can cause a problem in strength such as uneven shape, cracking of rib, or falling of rib.

Making the rib in a two-layer structure is one of conceivable methods of increasing the height of the rib. In a rib in the two-layer structure, in a process of forming the rib by a sandblast method, an upper-layer portion of the rib in the two-layer structure is made of a material having a higher blast rate and a lower-layer portion is made of a material having a lower blast rate to prevent breakage of the rib (see Patent Document 1). In another method, the upper layer of the rib in the two-layer structure is composed of a light transmission layer and the lower layer is composed of a light reflection layer to improve the light emission efficiency (see Patent Document 2).

However, a problem in the method described in the Patent Document 1 is that since the upper-layer portion is made of the material having a higher blast rate, the upper layer is also cut to be thin when processing the lower-layer portion made of the material having a lower blast rate. The processing only by the current sandblast method has a limit on the height of the rib that can be formed.

### (Patent Document 1)

Japanese Patent Application Laid-open No. 2002-63849

### (Patent Document 2)

Japanese Patent Application Laid-open No. 2002-298743

### SUMMARY OF THE INVENTION

An object of the present invention is to increase the height of the rib to enlarge the discharge space so as to improve the light emission efficiency of the plasma display panel.

The plasma display panel of the present invention is a plasma display panel having a discharge gas sealed in a gap between a front side substrate and a rear side substrate opposed to each other and having ribs partitioning a gas-sealed space into a discharge cell array arranged above an inner surface of one of the substrates wherein the rib includes an upper-layer rib and a lower-layer rib, and the upper-layer rib and the lower-layer rib are made of rib materials different from each other in resistance to etching.

The method of a manufacturing a plasma display panel is a method of manufacturing a plasma display panel having a discharge gas sealed in a gap between a front side substrate and a rear side substrate opposed to each other and having ribs partitioning a gas-sealed space into a discharge cell array arranged above an inner surface of one of the substrates, including the steps of: in forming the ribs, forming a first rib material film having resistance to first etching, on a dielectric layer formed on the inner surface of the one of the substrates; forming a second rib material film having resistance to second etching, on the first rib material film; forming a resist pattern on the second rib material film; processing the second rib material film by the first etching using the resist pattern as a mask to form an upper layer of the rib; and processing the first rib material film by the second etching to form a lower layer of the rib.

### BRIEF DESCRIPTION OF THE DRAWINGS

FIG. 1 is an exploded perspective view showing a configuration example of a plasma display panel in an embodiment of the present invention;

FIGS. 2A to 2G are schematic cross-sectional views showing a method of manufacturing the plasma display panel in this embodiment in a process order;

FIGS. 3A and 3B are views for explaining display light of the plasma display panel in this embodiment;

FIG. 4 is a diagram showing a configuration example of a plasma display device in this embodiment; and

FIG. 5 is an illustration showing one example of a gradation drive sequence of the plasma display device in this embodiment.

### DETAILED DESCRIPTION OF THE PREFERRED EMBODIMENTS

An embodiment of the present invention will be described below with reference to the drawings.

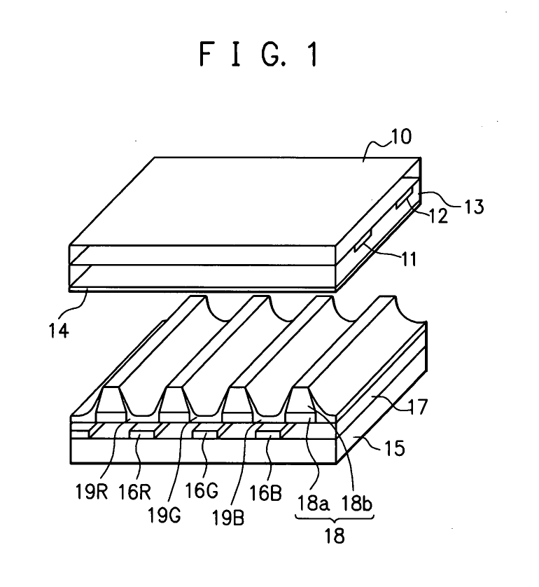

FIG. 1 is an exploded perspective view showing a configuration example of a plasma display panel in an embodiment of the present invention.

On a front glass substrate 10, X electrodes (sustain electrodes) 11 and Y electrodes (scanning electrodes) 12 that perform sustain discharge are formed arranged in parallel and alternately. On the electrodes 11 and 12, a dielectric layer 13 made of low-melting glass or the like is deposited. On the dielectric layer 13, an MgO (magnesium oxide) protective layer 14 is further deposited. In other words, the X electrodes 11 and the Y electrodes 12 arranged on the front glass substrate 10 are covered by the dielectric layer 13 whose surface is further covered by the protective layer 14.

Besides, on a rear glass substrate 15 arranged opposed to the front glass substrate 10, address electrodes 16R, 16G, and 16B are formed in a direction perpendicular to (in a manner to intersect) the X electrodes 11 and the Y electrodes 12. On the address electrodes 16R, 16G, and 16B, a dielectric layer 17 is deposited. On the dielectric layer 17, phosphors 19R, 19G, and 19B are deposited. Ribs 18 for partitioning cells in the column direction are arranged on both sides of the address electrodes 16R, 16G, and 16B. In the present embodiment, the rib 18 has a two-layer structure composed of a lower-layer rib 18a and an upper-layer rib 18b, and a rib forming material forming the lower-layer rib 18a and a rib forming material forming the upper-layer rib 18b are different in resistance to chemical etching.

On inner surfaces (side walls) of the ribs 18, the phosphors 19R, 19G, and 19B which are excited by ultraviolet rays to emit visible light of red (R), green (G), and blue (B) are applied arranged on each color basis. More specifically, the phosphor layer 19R which emits light of red is formed above the address electrode 16R, the phosphor layer 19G which emits light of green is formed above the address electrode 16G, and the phosphor layer 19B which emits light of blue is formed above the address electrode 16B. In other words, the address electrodes 16R, 16G, and 16B are arranged in a manner to correspond to the red, green, and blue phosphor layers 19R, 19G, and 19B applied on the inner surfaces of the ribs 18.

Namely, the address electrodes 16R, 16G, and 16B arranged on the rear glass substrate 15 are covered by the dielectric layer 17, and the ribs 18, which are composed of the lower-layer portions 18a and upper-layer portions 18b and partition discharge cells, are arranged on both sides of the address electrodes 16R, 16G, and 16B. The phosphor layers 19R, 19G, and 19B are applied on the upper surface of the dielectric layer 17 on the address electrodes 16R, 16G, and 16B and on the side walls of the ribs 18. Discharge between the X electrodes 11 and the Y electrodes 12 excites the phosphors 19R, 19G, and 19B to emit light of respective colors.

The front glass substrate 10 and the rear glass substrate 15 are sealed together such that the protective layer 14 is in contact with the ribs 18, and a discharge gas such as Ne—Xe or the like is sealed in between (in a discharge space between the front glass substrate 10 and the rear glass substrate 15) with a pressure of approximately 66.4 kPa (500 Torr) to constitute a plasma display panel.

Note that the ribs for partitioning the cells in the column direction may be added, and lateral ribs for partitioning the cells in the row direction may be arranged in the direction perpendicular to the address electrodes 16R, 16G, and 16B.

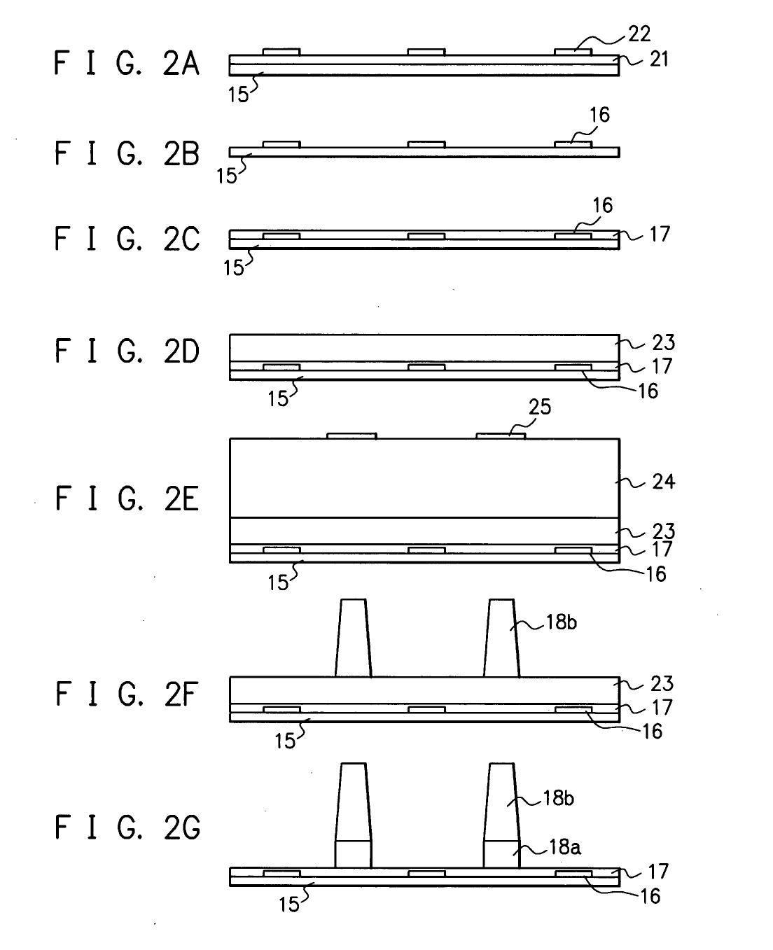

Next, a method of manufacturing a plasma display panel in this embodiment will be described. FIGS. 2A to 2G are schematic cross-sectional views showing the method of manufacturing the plasma display panel in this embodiment in a process order, showing only the rear side substrate.

As shown in FIG. 2A, an address electrode material film 21 is first formed (deposited) on the rear glass substrate 15. A resist film is further formed on the address electrode material film 21 and exposed to light and developed through a mask to form a resist pattern 22 for forming the address electrodes. Then, the address electrode material film 21 except portions corresponding to the address electrodes is removed by chemical etching using the resist pattern 22 as a mask, and the resist film is then removed. This forms the address electrodes 16 on the rear glass substrate 15 as shown in FIG. 2B. Subsequently, as show in FIG. 2C, the dielectric layer 17 is formed on the address electrodes 16 to cover the address electrodes 16.

As shown in FIG. 2D, a lower-layer rib forming material constituting the lower-layer ribs is then applied onto the dielectric layer 17 to form a lower-layer rib material film 23, and as shown in FIG. 2E, an upper-layer rib forming material constituting the upper-layer ribs is then applied onto the lower-layer rib material film 23 to form an upper-layer rib material film 24. Further, a resist film is formed on the upper-layer rib material film 24 and exposed to light and developed through a mask to form a resist pattern 25 for forming the ribs.

Here, a material made by adding alumina to silica (SiO₂) is used as the lower-layer rib forming material, and a low-melting glass (a material made by mixing lead oxide glass (PbO) and strengthening material such as alumina (Al₂O₃), zirconia (ZrO₂) or the like for strengthening the structure in an organic substance composed of ethyl cellulose, organic binder, organic solvent, or the like with a dispersant added thereto) is used as the upper-layer rib forming material.

Next, the upper-layer rib material film 24 is etched (cut) into the shape of ribs by the sandblast method using the resist pattern 25 as a mask to form the upper-layer ribs 18b on the lower-layer rib material film 23 as shown in FIG. 2F. Subsequently, the lower-layer rib material film 23 is etched into the shape of ribs by chemical etching using the upper-layer ribs 18b as a mask to form the lower-layer ribs 18a under the upper-layer ribs 18b as shown in FIG. 2G. It should be noted that since the upper-layer ribs 18b are made of a material different from the lower-layer rib forming material in resistance to chemical etching and have resistance to chemical etching when forming the lower-layer ribs 18a, the upper-layer ribs 18b are not affected by the chemical etching. Besides, the dielectric layer 17 serves as an etching stopper layer during the etching to protect the address electrodes and the surface of glass substrate.

The formation of the rib 18 in the two-layer structure composed of the lower-layer rib 18a and the upper-layer rib 18b as described above ensures that the height of the rib 18 is a height created by adding the height of the lower-layer rib 18a to the height of the upper-layer rib 18b which can be formed by the sandblast method, thereby forming the rib higher than the that in the conventional art without loss of quality to enlarge the discharge space. Accordingly, the light emission efficiency of the plasma display panel can be improved.

Note that the cutting speed when forming the ribs is generally greater by the sandblast method than that by the chemical etching, and therefore the height of the lower-layer rib 18a is preferably smaller the height of the upper-layer rib 18b.

Further, while the upper-layer rib 18b is formed by the sandblast method and the lower-layer rib 18a is formed by the chemical etching in the above description, the materials for the rib forming materials for the upper-layer ribs 18b and the lower-layer ribs 18a may be used such that their resistances to the chemical etching are reversed so that both the upper-layer ribs 18b and the lower-layer ribs 18a are formed by the chemical etching.

It is only required that the upper-layer ribs 18b are not affected at the time when processing the lower-layer ribs 18a, and therefore at least the rib forming material for the upper-layer ribs 18b preferably has resistance to the etching when forming the lower-layer ribs 18a, but the rib forming material for the lower-layer ribs 18a desirably has resistance to the etching when forming the upper-layer ribs 18b to prevent the lower-layer ribs 18a from being cut at the time of processing the upper-layer ribs 18b.

While the case in which the low-melting glass is used as the upper-layer rib forming material and the material made by adding alumina to silica is used as the lower-layer rib forming material is shown in the above description, the rib forming materials are not limited to them.

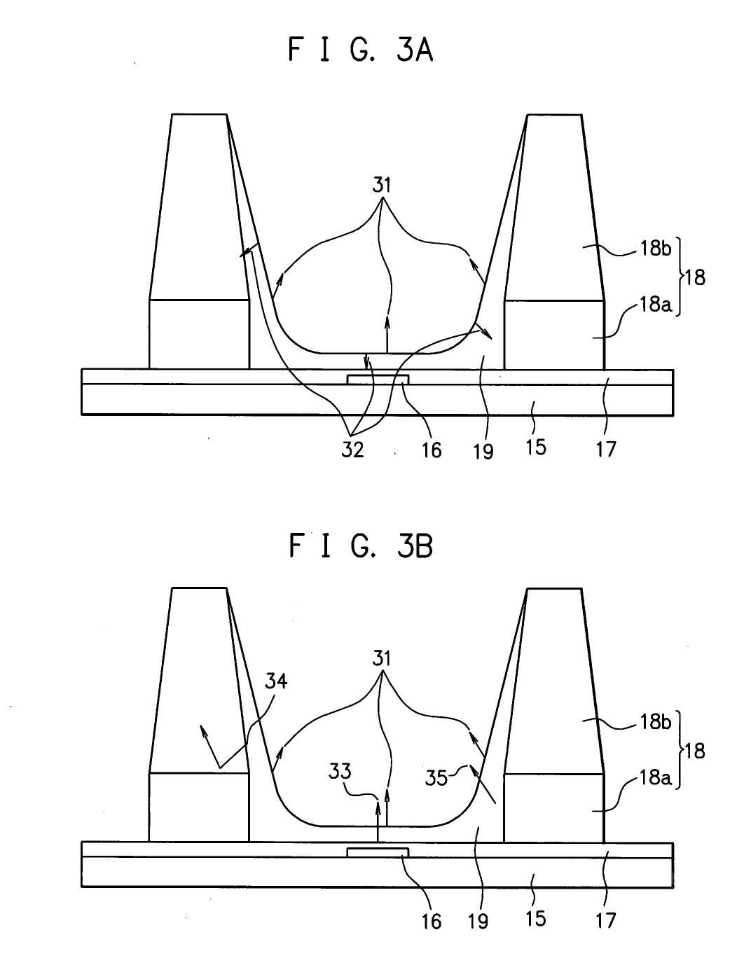

For example, the low-melting glass may be used as the upper-layer rib forming material and aluminum (Al) or copper (Cu) may be used as the lower-layer rib forming material to constitute the ribs. In such a configuration, the upper-layer rib 18b forms a light transmission layer having a light transmission property and the lower-layer rib 18a forms a light reflection layer reflecting light to make it possible to reflect the light emitted by the phosphor layer 19 as shown in FIG. 3B to further improve the light emission efficiency.

FIGS. 3A and 3B are views for explaining the display light of the plasma display panel having the upper-layer ribs 18b made of the low-melting glass and the lower-layer ribs 18a made of aluminum or copper. In FIGS. 3A and 3B, the same numbers are given to the same components as those shown in FIG. 1 to omit overlapping description. FIGS. 3A and 3B show the operation of the ribs 18 with respect to the light produced inside the plasma display panel 1.

The light emission in the plasma display panel 1 is performed by the red, green, and blue phosphors which are excited to emit light by ultraviolet rays generated by discharge. As shown in FIG. 3A, the light radiated from the phosphor is divided into light 31 emitted near the surface layer of the phosphor and going toward the front surface (on the front glass substrate side) and light 32 emitted near the surface layer of the phosphor and going toward the rear side of the phosphor layer (on the rear glass substrate side 15 and so on).

The light 32 going toward the rear side of the phosphor layer is reflected by the lower-layer rib 18a. More specifically, as shown in FIG. 3B, there are light 35 reflected by the lower-layer rib 18a and going toward the front surface and light 34 transmitted through the upper-layer rib 18b, reflected by the lower-layer rib 18a and going toward the front surface.

Further, the dielectric layer 17 is made of a dielectric containing titanium oxide or the like and thereby has a reflective property so that the dielectric layer 17 can also reflect the light 32 going toward the rear side of the phosphor layer. In this case, as shown in FIG. 3B, there is also light 33 reflected by the dielectric layer 17 and going toward the front surface.

The display light of the plasma display panel 1 is determined by the sum of the light 31 emitted near the surface layer of the phosphor and going toward the front surface, the light 35 traveling to the rear side of the phosphor layer, reflected by the lower-layer rib 18a and going toward the front surface, the light 34 transmitted through the upper-layer rib 18b, reflected by the lower-layer rib 18a and going toward the front surface, and the light 33 reflected by the dielectric layer 17 and going toward the front surface as shown in FIG. 3B.

Note that the lower-layer rib forming material for making the lower-layer rib 18a the light reflection layer is not limited to aluminum or copper but can be a material having a light reflective property.

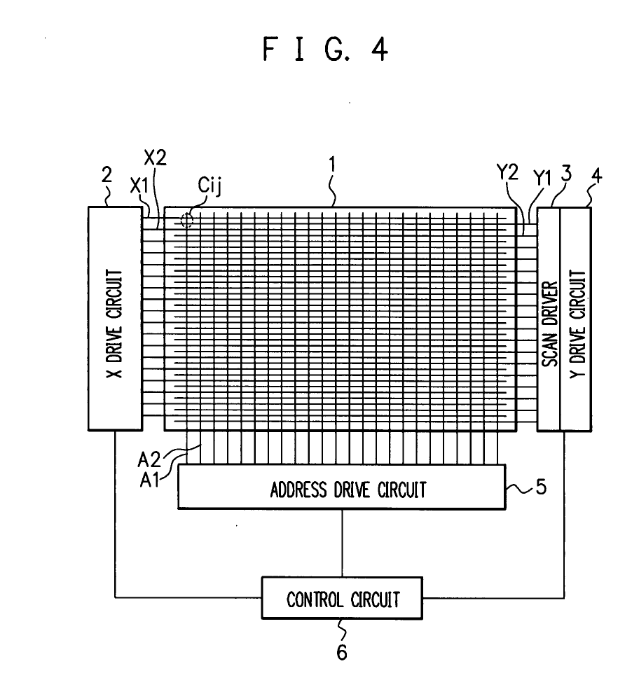

FIG. 4 is a diagram showing a configuration example of a plasma display device employing the plasma display panel in this embodiment. The plasma display device in this embodiment has the plasma display panel 1, an X drive circuit 2, a scan driver 3, a Y drive circuit 4, an address drive circuit 5, and a control circuit 6.

The X drive circuit 2 is composed of a circuit that repeats sustain discharge and feeds a predetermined voltage to a plurality of X electrodes (sustain electrodes) X1, X2, and so on. Hereinafter, each of the X electrodes X1, X2, and so on or their generic name is referred to as an X electrode Xi, i representing a suffix.

The scan driver 3 is composed of a circuit that performs line-sequential scanning and selects a row to be displayed, and the Y drive circuit 4 is composed of a circuit that repeats sustain discharge. The scan driver 3 and the Y drive circuit 4 feed predetermined voltages to a plurality of Y electrodes (scan electrodes) Y1, Y2, and so on. Hereinafter, each of the Y electrodes Y1, Y2, and so on or their generic name is referred to as a Y electrode Yi, i representing a suffix.

The address drive circuit 5 is composed of a circuit that selects a column to be displayed and feeds a predetermined voltage to a plurality of address electrodes A1, A2, and so on. Hereinafter, each of the address electrodes A1, A2, and so on or their generic name is referred to as an address electrode Aj, j representing a suffix.

The control circuit 6 generates control signals based on display data, a clock signal, a horizontal synchronization signal, and a vertical synchronization signal inputted from an external device such as a TV tuner, a computer or the like. The control circuit 6 supplies the generated signals to the X drive circuit 2, the scan driver 3, the Y drive circuit 4, and the address drive circuit 5 to control the drive circuits 2 to 5.

The X electrode Xi, the Y electrode Yi, and the address electrode Aj correspond to the X electrode 11, the Y electrode 12, and the address electrode 16 (16R, 16G, 16B) shown in FIG. 1, respectively. In the plasma display panel 1, the Y electrodes Yi and the X electrodes Xi form the rows extending in parallel in the horizontal direction, and the address electrodes Aj form the columns extending in the vertical direction. The Y electrodes Yi and the X electrodes Xi are arranged alternately in the vertical direction to form display lines. In other words, the Y electrodes Yi and the X electrodes Xi are arranged in parallel to each other. The Y electrodes Yi and the address electrodes Aj form a two dimensional matrix with i rows and j columns.

Cells Cij are formed of intersections of the Y electrodes Yi and the address electrodes Aj and the X electrodes Xi correspondingly adjacent thereto. The cells Cij correspond to red, green, and blue sub-pixels, the sub-pixels in three colors constituting one pixel. The panel 1 displays an image by lighting of a plurality of pixels arranged in a two-dimensional array. The scan driver 3 and the address drive circuit 5 determine which cell is caused to light, and the X drive circuit 2 and the Y drive circuit 4 repeatedly discharge, thereby performing display operation in the plasma display device.

More specifically, during the address period (address process), the scan driver 3 applies scan pulses to the Y electrodes Yi in sequence to select the Y electrodes Yi (display lines) so as to cause address discharge to select lighting (light emission)/non-lighting (non-light emission) of a cell between the address electrode Aj connected to the address drive circuit 5 and each of the Y electrodes Yi. Further, during the sustain period (display step), the X drive circuit 2 and the Y drive circuit 4 cause a number of sustain discharges corresponding to the weight in each sub-field for the cell selected by the address discharge.

A method of driving the plasma display device in this embodiment will be described.

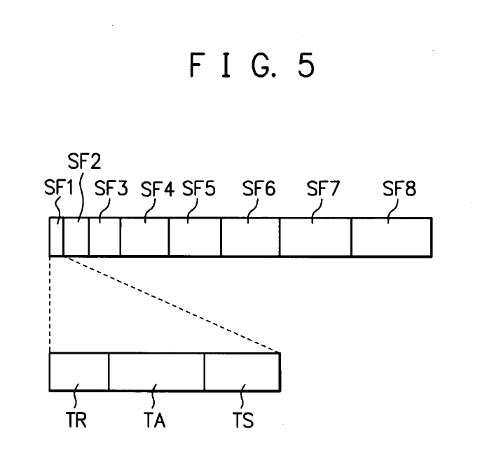

FIG. 5 is an illustration showing one example of a gradation drive sequence of the plasma display device in this embodiment. In this embodiment, the image is constituted of, for example, 60 fields/sec. One field is composed of a plurality of sub-fields each having a predetermined weight of luminance so that a desired gradation display is performed by combination of the sub-fields.

For example, in the example shown in FIG. 5, one field is formed of eight sub-fields each having a luminance weight of a power of 2 (a first sub-field SF1, a second sub-field SF2, . . . , and an eighth sub-field SF8). The first to eighth sub-fields SF1 to SF8 have a ratio of the numbers of sustain discharge times of 1:2:4:8:16:32:64:128 and can display 256 gradations. Note that various combinations of the number of sub-fields and the weight of each sub-field are possible.

Each of the sub-fields SF1 to SF8 is composed of a reset period (initialization process) TR to uniform the wall charges of all cells constituting the display screen, an address period (address process) TA to select a cell to light, and a sustain (sustain discharge) period (display process) TS to cause the selected cell to discharge (light) a number of times corresponding to the luminance (the weight of each field).

During the reset period TR, a predetermined voltage is applied to the X electrodes Xi and the Y electrodes Yi constituting all display lines to cause all cells Cij to generate reset discharge, thereby performing initialization.

During the address period TA, selection of light emission or non-light emission of each cell Cij is performed by addressing. During the address period TA, the scan pulses are applied to the Y electrodes Y1, Y2, and so on in sequence, and the address pulse is applied to the selected address electrode Aj in accordance with the scan pulse to cause the cell Cij, which should emit light, to generate address discharge. Specifically, when the address pulse is generated in accordance with the scan pulse, address discharge is caused between the address electrode Aj and the Y electrode Yi and is used as a pilot flame to cause discharge between the X electrode Xi and the Y electrode Yi. This allows negative charges to build up on the X electrode Xi and positive charges to build up on the Y electrode Yi, resulting in formation of an amount of wall charges in the cell which are capable of sustain discharge to be performed during the subsequent sustain period TS.

During the sustain period TS, sustain pulses having mutually opposite phases are applied to the X electrode Xi and the Y electrode Yi so that sustain discharge is performed between the X electrode xi and the Y electrode Yi of the cell selected during the address period TA to emit light. In each of the sub-fields SF1 to SF8 shown in FIG. 5, the numbers of sustain pulses to be applied to the X electrode Xi and the Y electrode Yi (the numbers of light emission times in the sub-fields) are different. Accordingly, the gradation value can be determined by appropriately selecting light emission or non-light emission in the sub-fields SF1 to SF8 for each cell Cij.

It should be noted that while the case in which the rib 18 has a two-layer structure is shown as an example in the above-described embodiment, the rib 18 is not limited to the above but may have a multilayer structure composed of a plurality of layers in which the upper-layer portion of the rib is different from the lower-layer portion in resistance to etching.

Further, the present invention is applicable to various types of plasma display devices, and widely applicable, for example, to a plasma display device of a personal computer, a work station or the like, a flat-type wall-hung television, or a plasma display device used as a device for displaying advertisement, information or the like.

According to the present invention, the rib materials forming the upper-layer ribs and the lower-layer ribs are different in resistance to etching, thus allowing for formation of high ribs with an excellent quality to enlarge the discharge space without affecting the upper-layer ribs when forming the lower-layer ribs. This can improve the light emission efficiency of the plasma display panel.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A plasma display panel having a discharge gas sealed in a gap between a front side substrate and a rear side substrate opposed to each other and having ribs partitioning a gas-sealed space into a discharge cell array arranged above an inner surface of one of said substrates, wherein
said rib comprises an upper-layer rib and a lower-layer rib, and said upper-layer rib and said lower-layer rib are made of rib materials different from each other in resistance to etching.

2. The plasma display panel according to claim 1, wherein said upper-layer rib is made of a rib material having resistance to etching to form said lower-layer rib.

3. The plasma display panel according to claim 2, wherein said upper-layer rib is a light transmission layer, and said lower-layer rib is a light reflection layer.

4. The plasma display panel according to claim 3, wherein said upper-layer rib is made of a low-melting glass, and said lower-layer rib is made of aluminum or copper.

5. The plasma display panel according to claim 3, wherein a plurality of electrodes generating surface discharge and a first dielectric layer covering said electrodes are provided on an inner surface of said front side substrate, a plurality of address electrodes generating address discharge arranged in a direction intersecting said electrodes for surface discharge and a second dielectric layer having a light reflective property covering said address electrodes are provided on said rear side substrate, and said ribs are provided on said second dielectric layer.

6. The plasma display panel according to claim 2, wherein a plurality of electrodes generating surface discharge and a first dielectric layer covering said electrodes are provided on an inner surface of said front side substrate, a plurality of address electrodes generating address discharge arranged in a direction intersecting said electrodes for surface discharge and a second dielectric layer covering said address electrodes are provided on said rear side substrate, and said ribs are provided on said second dielectric layer.

7. The plasma display panel according to claim 6, wherein said second dielectric layer has a light reflective property.

8. The plasma display panel according to claim 1, wherein said upper-layer rib is formed by sandblast, and said lower-layer rib is formed by chemical etching.

9. The plasma display panel according to claim 1, wherein said upper-layer rib is a light transmission layer, and said lower-layer rib is a light reflection layer.

10. The plasma display panel according to claim 9, wherein said upper-layer rib is made of a low-melting glass, and said lower-layer rib is made of aluminum or copper.

11. The plasma display panel according to claim 9, wherein a plurality of electrodes generating surface discharge and a first dielectric layer covering said electrodes are provided on an inner surface of said front side substrate, a plurality of address electrodes generating address discharge arranged in a direction intersecting said electrodes for surface discharge and a second dielectric layer having a light reflective property covering said address electrodes are provided on said rear side substrate, and said ribs are provided on said second dielectric layer.

12. The plasma display panel according to claim 1, wherein a plurality of electrodes generating surface discharge and a first dielectric layer covering said electrodes are provided on an inner surface of said front side substrate, a plurality of address electrodes generating address discharge arranged in a direction intersecting said electrodes for surface discharge and a second dielectric layer covering said address electrodes are provided on said rear side substrate, and said ribs are provided on said second dielectric layer.

13. The plasma display panel according to claim 12, wherein said second dielectric layer has a light reflective property.

14. A method of manufacturing a plasma display panel having a discharge gas sealed in a gap between a front side substrate and a rear side substrate opposed to each other and having ribs partitioning a gas-sealed space into a discharge cell array arranged above an inner surface of one of the substrates, comprising the steps of:
in forming the ribs,
forming a first rib material film having resistance to first etching, on a dielectric layer formed on the inner surface of the one of the substrates;
forming a second rib material film having resistance to second etching, on the first rib material film;
forming a resist pattern on the second rib material film;
processing the second rib material film by the first etching using the resist pattern as a mask to form an upper layer of the rib; and
processing the first rib material film by the second etching to form a lower layer of the rib.

15. The method of manufacturing a plasma display panel according to claim 14, wherein the first etching is sandblast, and the second etching is chemical etching.

16. The method of manufacturing a plasma display panel according to claim 14, wherein both of the first etching and the second etching are chemical etching.
